(19) United States
(12) Patent Application Publication
(10) Pub. No.: US 2025/0104888 A1
(43) Pub. Date: Mar. 27, 2025

(54) AUDIO CABLE WITH DIELECTRIC FLUID

(71) Applicant: Kenneth KEGEL, Newton Square, PA (US)

(72) Inventor: Kenneth KEGEL, Newton Square, PA (US)

(21) Appl. No.: 18/730,954

(22) PCT Filed: Jan. 25, 2023
(86) PCT No.: PCT/US2023/011516

§ 371 Date: Jul. 22, 2024

Related U.S. Application Data
(60) Provisional application No. 63/302,815, filed on Jan. 25, 2022.

(51) Int. Cl. H01B 11/06; H01B 3/00

(52) U.S. Cl. CPC H01B 11/06; H01B 3/008

(57) ABSTRACT

A cable is provided. The cable includes a conductor and a casing housing the conductor. The cable includes spacers suspending the conductor within the casing. The cable includes a dielectric fluid. The dielectric is within the casing and immersing the conductor. The dielectric fluid prevents or quenches electric discharges from the conductor.

### CROSS REFERENCE TO RELATED APPLICATION

This application claims the benefit of U.S. Provisional Application No. 63/302,815, filed Jan. 25, 2022 and is incorporated here by reference in its entirety.

### FIELD OF INVENTION

This disclosure is related to methods and systems for signal transmission, and more particularly to an audio cable including a dielectric fluid for enhanced signal transmission.

### BACKGROUND

Today, homes and cars are filled with unwanted signals that are unfriendly to audio signal transmissions between speakers and signal generators, especially transmissions by high-end equipment like an integrated amplifier at 350 watts per channel at 20 Hz to 20,000 Hz to speakers. These unwanted signals can cause even the best recorded music to sound bright and fatiguing. Cable replacement, as well as replacement of other elements in a connection chain (e.g., power cords, interconnects, filtering components, connector, etc.) between speakers and signal generators, attempts to address the unwanted signal problem. However, conventional cables presently offer limited signal transmission capabilities that fail to shield audio signal transmission for these unwanted signals.

By way of example, while conventional speaker cables can be manufactured with different geometries and insulation schemes to reduce effects of resistance, reactance, vibration, impedance, skin effect, electro motive force capacitance, etc., conventional speaker cables offer limited signal transmission capabilities while being extremely expensive (i.e., greater than $71,500 per 01.5 meters).

Also, by way of example, while conventional optical cables have no conductor to cause distortion, conventional optical cables will not transmit high resolution recordings on streaming services (as conventional optical cables, such as Toslink optical cables, only transmit at 44.1 KHz or compact disc quality).

### SUMMARY

According to one or more embodiments, a cable is provided. The cable includes a conductor and a casing housing the conductor. The cable includes spacers suspending the conductor within the casing. The cable includes a dielectric fluid. The dielectric is within the casing and immersing the conductor. The dielectric fluid prevents or quenches electric discharges from the conductor.

The cable can be provided as a system, a method, and/or as a cable pair.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1 depicts a cross-sectional view of a cable according to one or more embodiments;

FIG. 2 depicts a side-view schematic of a cable according to one or more embodiments;

FIG. 3 depicts a side-view schematic of a termination of a cable according to one or more embodiments;

FIG. 4 depicts a cable pair according to one or more embodiments; and

FIG. 5 depicts method of assembling a cable according to one or more embodiments.

### DETAILED DESCRIPTION

This disclosure is related to methods and systems for signal transmission, and more particularly to an audio cable including a dielectric fluid for enhanced signal transmission. According to one or more embodiment, the audio cable provides an improve performance over conventional cables and may be utilized in high end audio and video equipment (e.g., for home or automobile use).

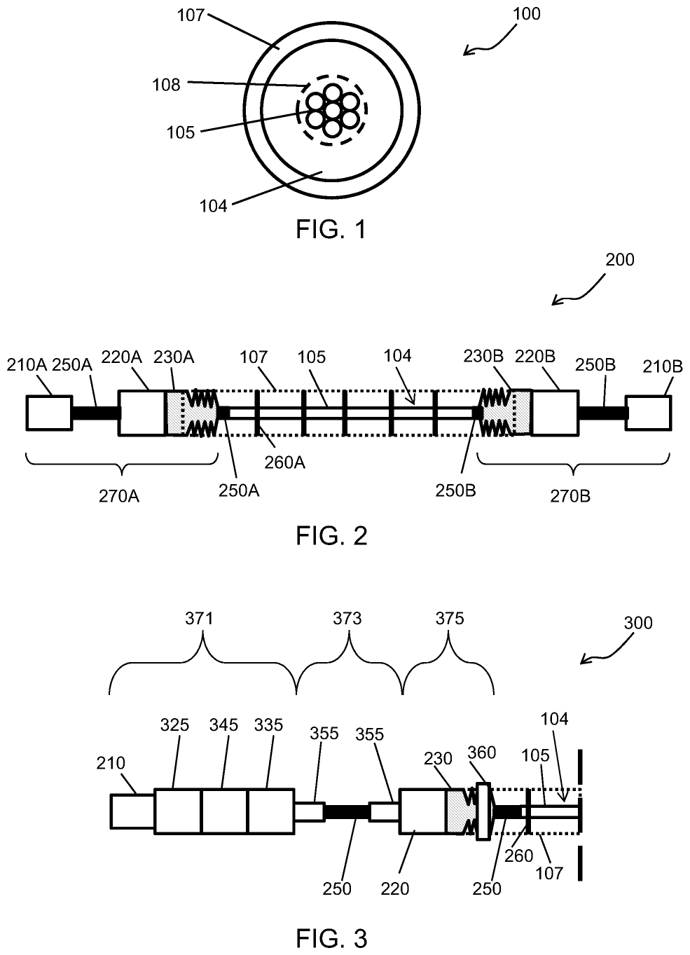

FIG. 1 depicts a cross-sectional view of a cable 100 according to one or more embodiments. The cable 100 includes a dielectric fluid 104, a wire 105, and a casing 107. The cable 100 can carry high-powered electrical currents required to move internal components of a speaker (i.e., magnets that move drivers therein). In manufacturing, the cable 100 can be pulled into the casing 107, which is then filled with the dielectric fluid 104 and sealed on each end.

The dielectric fluid 104 is within the casing 107 and immerses the wire 105. The dielectric fluid 104 (i.e., an insulator) includes any dielectric material (e.g., in a liquid state) that prevents or rapidly quenches electric discharges from the wire 105. The dielectric fluid 104 can be biodegradable (e.g., 98% biodegradable), non-toxic, non-halogenate, ozone safe (e.g., 100% ozone safe), devoid of toxic waste, and/or devoid of toxic vapors. For example, the dielectric fluid 104 provides electrical insulation of 40,000 volts, suppresses corona and arcing, and/or serve as a coolant for the cable 100. Example of the dielectric fluid 104 include, but are not limited to, dielectric oil of any formulation (e.g., Electrocool Ec-100). The dielectric fluid 104 can be food grade, have no sheen, include no odor, and/or be colorless or died.

The wire 105 (i.e., a conductor) includes a flexible conductor used to carry electric current in a circuit. The wire 105 can be metallic, such as copper, silver, other metal, or any combination thereof. The wire 105 can be a single strand. The wire 105 can include two or more individual strands braided together (e.g., shown as sever (7) individual strands). The wire 105 can be speaker cable or wire. An example of the wire 107 can include a power cord, balanced audio cable, data cords, HDMI cables, component audio and video cables, composite video cables, RF cables, 75 ohm coaxial cable with a quality of transmission at 90 kHz or greater, which is more than twice the transmission standard. By way of example, the wire 105 can be 11.5 American wire gauge (AWG) 6N Ohno continuous cast (OCC) conductor with multiple size strands.

According to one or more embodiments, the dielectric fluid 104 can surround and penetrate into the wire 105 to provide a liquid insulation that prevents or rapidly quenches electric discharges from the wire 105 (e.g., individual strands thereof).

According to one or more embodiments, the cable 100 can optionally include an insulation 108 (as represented by the dashed circle) that insulated the wire 105. The insulation 108 can be a nonconducting material. Examples of nonconducting material include, but are not limited to paper, cotton, plastic jacket, and rubber sleeve.

According to one or more embodiments, the wire 105 can provide a quality of transmission at 384 kHz, which has eight (8) times the quality of a compact disc. The wire 105 can have a gage of 10.34 mm (outer diameter).

The casing 107 (i.e., a conduit) includes a long, hollow cylinder of metal, plastic, glass, etc. for housing, holding, or transporting the dielectric fluid 104 and the wire 105. According to one or more embodiments, the casing 107 can be transparent, semi-transparent, or non-transparent. An example of the casing 107 can include a polyurethane ester based clear tubing (e.g., ⅜ ID.×½ OD. 1/16 wall). Another example of the casing 107 can include ⅝ inch tubing.

FIG. 2 depicts a side-view schematic of a cable 200 according to one or more embodiments. The cable 200 includes wire connectors 210, cable glands 220, hose barbs 230, insulated portion 250 of the wire 105, and spacers 260. Further, FIG. 2 depicts terminations 270 of the cable 200, with a termination 270A being a first side and with a termination 270B being a second side (opposite the first side). Elements of FIG. 2 that are similar to elements of FIG. 1 are reused for brevity and are not introduced.

According to one or more embodiments, the wire connectors 210, the cable glands 220, and the hose barbs 230 are configured to terminate the cable 200 by ensuring proper attachment to equipment. That is, the wire connector 210A, the cable gland 220A, the hose barb 230A, and the insulated portion 250A operate in concert to seal the casing 107 and terminate the cable 200 on the first side, and the wire connector 210B, the cable gland 220B, the hose barb 230B, and the insulated portion 250B operate in concert to seal the casing 107 and terminate the cable 200 on the second side (opposite the first side).

The wire connector 210 connects the cable 200 to other cables or equipment (e.g., speakers and signal generators). For example, the wire connector 210 can connect to an output of power amplifier, an amplifier section of a receiver, or a speaker. Examples of the wire connector 210 can include, but are not limited to, spade connectors, socket connectors, pin connectors, banana plugs, alligator wire connectors, terminal plugs, and exposed wire.

The cable gland 220 includes an element to seal and/or compress the cable 200 to protect against water and dust ingress into the casing 107 and secure the dielectric fluid 104 from egress out of the casing 107. An example of the cable gland 220 includes, but is not limited to, ¼ National Pipe Tapered (NPT) thread 3-6 mm compression wire gland.

The hose barb 230 includes a fitting with one or more continuous ridges or bumps that grip an inside diameter of the casing 107 and seal the casing 107. An example of the hose barbs 230 includes, but is not limited to, ⅜ hose barb ¼ female NPT thread.

According to one or more embodiments, the cable gland 220 and the hose barb 230 can be screwed together to terminate the casing 107. In this regard, the casing 107 is installed on the hose barb 230 by sliding the casing 107 across over the fitting of the hose barb 230, such that the casing 107 expands over the one or more continuous ridges or bumps to enable a grip and a seal. That is, after expanding, the casing 107 relaxes to an original inside diameter behind or over the fitting of the hose barb 230. Thus, the cable gland 220 works in concert with the hose barb 230 to seal the cable 200 (e.g., a seal maintains the connection and also keeps out dust and moisture).

The insulated wire 250 is a covered portion of the wire 105. The insulated wire 250 can be covered with a nonconducting material. Examples of nonconducting material include, but are not limited to paper, cotton, plastic jacket, and rubber sleeve.

The spacer 260 is a device or piece used to create or maintain a desired amount of space between two parts. By way of example, the spacer 260 can be a disc that has a diameter that is equal to or less than an interior diameter of the casing 107. Further, the spacer 260 can include an center opening that include a diameter that can accommodate the exterior diameter of the wire 105 or the insulated wire 250. As shown in FIG. 2, a plurality of spacers 260 are positioned along the wire 105 to maintain a central position of the wire 105 within the casing 107. An example of the spacer 260 can include, but is not limited to a silicone spacer.

FIG. 3 depicts a side-view schematic of a termination of a cable 300 according to one or more embodiments. The cable 300 includes cable glands 325 and 335, coupling 345, spacers 355, and clamp 360. Elements of FIG. 3 that are similar to elements of FIGS. 1-2 are reused for brevity and are not introduced.

The cable glands 325 and 335 can include an element to seal and/or compress the wire 105 of the cable 300. The coupling 345 can include an element to join or connect the cable glands 325 and 335.

The spacer 355 can be any element that provides flexible support. An example of the spacer 355 can include, but is not limited to, a rubber spacer. To provide the flexible support, the spacer 355 can abut ends of the cable glands 325 and 335 to protect over bending of the wire 105 at the ends of the cable glands 325. The clamp 360 can be any ring clamp, pipe clamp, pinch clamp, or the like that is configured to secure the casing 107 on the fitting of the hose barb 230.

According to one or more embodiments, one or each of the cable glands 220, 325, and 335 can include different screw sizes to provide the technical effects, advantages, and benefits of providing different compression level and tighter seals to prevent leaking. For instance, the cable glands 220, 325, and 335 go over the wire connector 210 and the wire 250 to prevent leakage of the dielectric fluid 104 from the casing 107 and/or through the wire connector 210 (e.g., leaking through screw holes).

A termination of the cable 300 includes a combination of sections 371, 373, and 375. According to one or more embodiments, the section 371 is a connector portion thereof configurable to provide a hookup or connection to any equipment, while a section 373 is a flexible portion to provide stress relief to the wire 105 when the cable 300 is connected to equipment (e.g., the cable 300 is able to be angles away from a fixed, a wired, or a screwed location of the equipment. Further, the section 375 is a cap portion to provide a seal to the casing 107.

According to one or more embodiments, any one of the cables 100, 200, and 300 or portions thereof can optionally include a cable dressing, such as heat shrink and fabric to add additional protection and insulation. For example, the sections 371, 373, and 375 can include the cable dressing, while a remaining portion of the casing 107 is left un-dressed and transparent so the wire 105 therein can be seen directly.

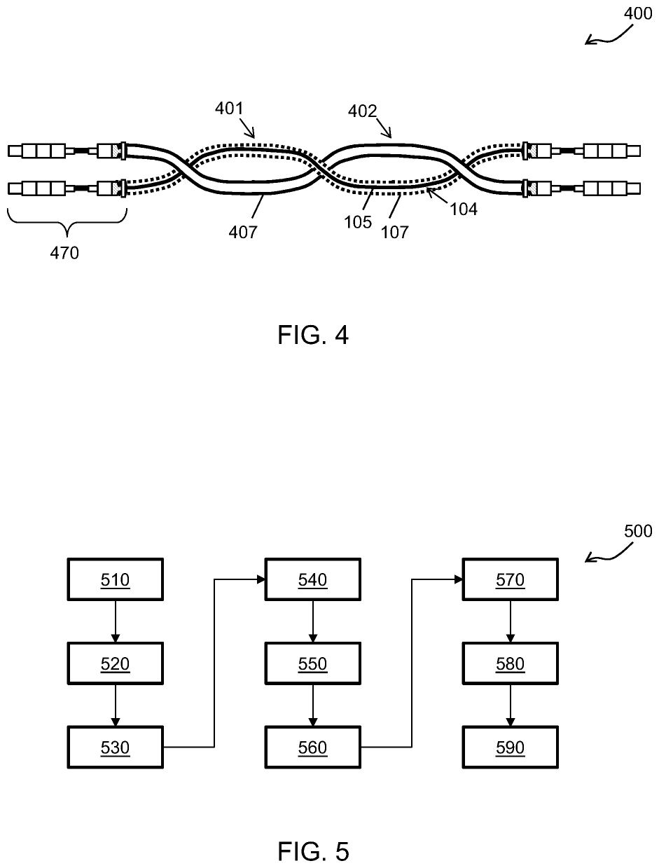

FIG. 4 depicts a cable pair 400 according to one or more embodiments. Elements of FIG. 4 that are similar to elements of previous figures are reused for brevity and are not introduced.

The cable pair 400 includes a first cable 401 and a second cable 402. By way of example, the first cable 401 includes a first conductor and a first conduit (i.e., shown as the wire 105 and the casing 107, respectively). The first conduit can contain therein a dielectric material (i.e., the dielectric fluid 104) that surrounds the first conductor, as well as one or more spacers 260 (depicted in FIGS. 2-3) that suspend the first conductor within the first conduit. The first cable 401 and the second cable 402 can be similarly constructed. In this regard, the second cable 402 also includes a dielectric material contained within a second conduit, in which a second conductor is suspended by spacers 260 therein. According to one or more embodiments, the first cable 401 and the second cable 402 can be braided. According to one or more embodiments, one of the first cable 401 and the second cable 402 can provide a neutral connection. According to one or more embodiments, the first cable 401 is transparent as shown by the dashed lines, and the second cable 402 is opaque as shown by the solid lines. As shown in FIG. 4, each cable 401 and 402 of the cable pair 400 can include a termination 470, as shown in FIGS. 2-3.

FIG. 5 depicts a method 500 of assembling the cable pair 400 according to one or more embodiments. The method 500 of FIG. 5 is described with respect to the elements of the previous figures.

The method 500 begins at block 510, where the cable gland 220A and the hose barb 230A are coupled. Further, the coupled cable gland 220A and hose barb 230A are slid over the wire 105 on the first side/end of the cable 401. Furthermore, the wire connector 210A is further fitted to the wire 105 according to one or more embodiments. Optionally, the cable glands 325 and 335 can be added with spacers 355 to further seal the first side/end.

At block 520, the wire 105 is fed through the casing 107. Further, the casing 107 is slid over the fitting of the hose barb 230A to secure a seal (i.e., secure the casing 107 on the fitting of the hose barb 230A). Furthermore, the spacers 260 can be added to the wire 105 before being fed through the casing 107 or while being fed through the casing 107.

Optionally, the clamp 360 can be added to further secure a seal by the casing 107 on the fitting of the hose barb 230A. One or more technical effects and benefits of the securing the seal is to prevent the ingress of moisture and oxygen into the casing. Note that moisture and oxygen will corrode the wire 105, as well as also cause signal transfer differences.

At block 530, with the first side/end sealed, the dielectric fluid 104 is provided into the casing 107 at the second side/end. By providing the dielectric fluid 104 into the casing 107, the dielectric fluid 104 immerses the wire 105. According to one or more experiments, the cables 200, 300, 401, and 402 that result from the method 500 excels in soundstage and provides exception holographic sound compared to conventional cables at least because the dielectric fluid 104 provides insulating qualities directly to the wire, such as preventing or rapidly quenching electric discharges. Note that, when the wire 105 includes two or more strands, the dielectric fluid 104 provides 42,000 volts per mm immerses around each of the two or more strands to provide insulating value per strain (i.e., which greatly reduces a skin effect for conductors).

At block 540, the partially assembled cable can be hung vertically with the second side/end being higher than the first side/end. The partially assembled cable can hang for a time period (e.g., twenty-four (24) hours) that allows any air to rise to the second side/end (i.e., an open end). By hanging the partially assembled cable, the dielectric fluid 104 flows down to the wire connector 210A.

At block 550, a vibrating tool is applied to the partially assembled cable. The vibrating tool vibrates the partially assembled cable to agitate any trapped air bubbles, which causes the trapped air bubbles to rise and escape through the open end. The application of the vibrating tool can be performed one or more times while the partially assembled cable is hung.

At block 560, heat is applied to the partially assembled cable. According to one or more embodiments, a heat gun or lamp is used to heat the partially assembled cable (i.e., the dielectric fluid 104 and the wire 105 within into the casing 107). Heating can cause any trapped air bubbles to rise and escape through the open end. Also, heating can create a finite mist from any trapped moisture that also rises and escapes through the open end, which removes the moisture. Thus, one or more technical effects, benefits, and advantages of the method 500 (i.e., blocks 540, 550, and 560) include the cable 401 being primarily free of oxygen and moisture. In contrast, conventional cables are cryogenically treated, which drastically increases costs.

At block 570, the second side/end is terminated. Generally, the steps of blocks 510, 520, and 530 are repeated for the second side/end to seal the second side/end. According to one or more embodiments, the cable 401 by the method 500 accounts for a possibility of a small amount of oxygen and/or moisture (e.g., a bubble of oxygen at 2.1 cubic centimeters or less, such as 2 cubic centimeters) being within the cable 401 after the second side/end is sealed. This small amount of oxygen and/or moisture allows for an expansion of the dielectric fluid 104 while the cable 401 is operating. Additionally, the small amount of oxygen and/or moisture tends to rise to the highest point of the cable 401 (e.g., at the equipment) and is captured with in the hose barb 240, so as not to contact and degrade the wire 105.

At block 580, the cable 402 is assembled in parallel or in series with the cable 401. The cable 402 is assembled as detailed in block 510, 520, 530, 540, 550, 560, and 570. Note that the case 107 used for cable 402 can be opaque.

At block 590, with both cables 401 and 402 assembles, the cable pair 400 is made. For example, the first side/end of both cables 401 and 402 are placed adjacent and dressed. The length of both cables 401 and 402 are twisted to provide a twisted cable pair. Then, the second side/end of both cables 401 and 402 are placed adjacent and dressed.

The figures illustrate the architecture, functionality, and operation of possible implementations of systems and methods according to various embodiments. Although features and elements are described above in particular combinations, one of ordinary skill in the art will appreciate that each feature or element can be used alone or in any combination with the other features and elements.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The descriptions of the various embodiments herein have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A cable comprising:
a conductor;
a casing housing the conductor;
one or more spacers suspending the conductor within the casing; and
a dielectric fluid within the casing and immersing the conductor, wherein the dielectric fluid prevents or quenches electric discharges from the conductor.

2. The cable of claim 1, wherein the cable comprises a speaker cable or wire.

3. The cable of claim 1, wherein the dielectric fluid comprises a dielectric oil.

4. The cable of claim 1, wherein the one or more spacers comprise silicone spacers.

5. The cable of claim 1, wherein the cable comprises one or more wire glands.

6. The cable of claim 1, wherein the cable comprises a hose barb and a wire gland coupled together and slid over the conductor to provide a seal at an end of the casing.

7. The cable of claim 6, wherein the cable comprises a second wire gland.

8. The cable of claim 7, wherein the cable comprises one or more rubber spaces between the wire gland and the second wire gland, the one or more rubber spaces to providing flexible support to the cable.

9. The cable of claim 1, wherein the cable comprises a wire connector.

10. A cable pair comprising the cable of claim 1 and a second conductor providing a neutral connection.

11. A method of assembling a cable, the method comprising:
coupling a cable gland and a hose barb;
sliding the cable gland and the hose barb over a conductor on a first end of the cable;
feeding the conductor through a casing;
sliding the casing over a fitting of the hose barb to secure a seal on the first end;
providing a dielectric fluid into the casing at a second end of the cable, the dielectric fluid immerses the conductor; a
agitating air or moisture from the cable; and
sealing the second end of the cable with a second cable gland and a second hose barb.

12. The method of claim 11, further comprising:
fitting a wire connector onto the first end of the cable.

13. The method of claim 11, further comprising:
adding one or more additional cable glands with spacers to the first end of the cable.

14. The method of claim 11, further comprising:
adding a clamp to the casing over the hose barb.

15. The method of claim 11, wherein the conductor includes two or more strands around which the dielectric fluid flows.

16. The method of claim 11, wherein cable is hung vertically for a period of time.

17. The method of claim 11, wherein cable is hung vertically with the second end being higher than the first end when providing the dielectric fluid to allows air to rise to the second end.

18. The method of claim 11, further comprising:
applying a vibrating tool to the cable to agitate the air.

19. The method of claim 11, further comprising:
applying heat to the cable to agitate the moisture.

20. The method of claim 11, further comprising:
adding a second cable to the cable;
twisting the cable and the second cable to provide a twisted cable pair; and
adding cable dressing to ends of the twisted cable pair.
